(19) United States
(12) Patent Application Publication
(10) Pub. No.: US 2009/0292688 A1
(43) Pub. Date: Nov. 26, 2009

(54) ORDERING RELEVANT CONTENT BY TIME FOR DETERMINING TOP PICKS

(75) Inventors: Scott ROY, Palo Alto, CA (US); Joe Toms Zachariah, San Jose, CA (US); Timothy Ho Rechin, San Carlos, CA (US); John McCabe, Los Altos Hills, CA (US)

Correspondence Address: YAHOO C/O MOFO PALO ALTO, 755 PAGE MILL ROAD, PALO ALTO, CA, 94304, US

(73) Assignee: YAHOO! INC., Sunnyvale, CA (US)

(21) Appl. No.: 12/126,797

(22) Filed: May 23, 2008

(51) Int. Cl. G06F 17/30

(52) U.S. Cl. 707/5; 707/E17.107

(57) ABSTRACT

A computer-readable medium encoded with computer instructions for providing relevant content on a web page for a user is provided. According to embodiments of the invention, the instructions are for determining a relevance metric for at least two articles. Each article of the at least two articles is selected from content of the user. Each article is associated with a time. The instructions further include instructions for selecting a set of relevant articles based on the relevance metric and ordering the set of relevant articles according to the associated time of each article of the set. The instructions also include instructions for providing the ordered set of relevant articles to the user.

### BACKGROUND OF THE INVENTION

In general, an Internet webpage includes content that is not personalized to any one user. However, it is becoming more popular to allow a user to specify content on a webpage as a mechanism for personalizing a webpage. While static web pages are useful in many applications where the information to be presented to each requesting user is the same, some applications require personalization to appeal to users. For example, in presenting news to users, personalized pages present news which is more relevant to the requesting users than static pages. With static web pages, a user will often have to scroll through many topics not of interest to that user to get to the information of interest. With personalized pages, the information is filtered according to each user's interest.

A user may choose to include content such as local weather or movie times for nearby theaters, for example. Furthermore, a user may have interests in particular news article content. For example, the user may have interests in sports and entertainment and, therefore, would prefer to be provided with access to sports and entertainment news stories as personalized content for a webpage.

However, with several news articles related to sports and entertainment, a user may want to see particular news articles based on the user's own interests. Previously, a webpage could be generated so that a user is provided with relevant news articles that were determined by a group of users actively marking news articles as relevant. However, the group of users may not have similar interests as the user requesting the page. Moreover, the group of users may have determined news articles that are no longer current as relevant.

Currently, content can be filtered and sorted and provided to the user. However, it is not apparent to the user which of the provided content is more current.

Therefore, a method and system for determining current relevant content for a particular user, is desired.

### BRIEF SUMMARY OF THE INVENTION

In accordance with embodiments of the present invention, a computer-readable medium encoded with computer instructions for providing relevant content on a web page for a user is provided. According to embodiments of the invention, the instructions are for determining a relevance metric for at least two articles. Each article of the at least two articles is selected from content of the user. Each article is associated with a time. The instructions further include instructions for selecting a set of relevant articles based on the relevance metric and ordering the set of relevant articles according to the associated time of each article of the set. The instructions also include instructions for providing the ordered set of relevant articles to the user.

In accordance with some embodiments of the present invention, a method for providing relevant content on a web page for a user is provided. The method includes determining a relevance metric for at least two articles. Each article is selected from content of the user, and each article is associated with a time. The method further includes selecting a set of relevant articles based on the relevance metric. After ordering the set of relevant articles according to the associated time of each article of the set the ordered set of relevant articles is provided to the user.

Furthermore, in accordance with some embodiments of the present invention, an apparatus for providing relevant content on a web page for a user is provided. The apparatus includes logic operable for determining a relevance metric for at least two articles. Each article is selected from content of the user, and each article is associated with a time. The apparatus includes logic operable for selecting a set of relevant articles based on the relevance metric and logic operable for ordering the set of relevant articles according to the associated time. The apparatus further includes logic operable for providing the ordered set of relevant articles to the user.

Other features and aspects of the invention will become apparent from the following detailed description, taken in conjunction with the accompanying drawings which illustrate, by way of example, the features in accordance with embodiments of the invention. The summary is not intended to limit the scope of the invention.

### BRIEF DESCRIPTION OF THE DRAWINGS

FIG. 1 illustrates a flowchart of the method of providing relevant content on a web page for a user according to embodiments of the invention;

FIG. 2 illustrates embodiments of relevant content for a user according to embodiments of the invention;

FIG. 3 illustrates a block diagram of a system for providing relevant content on a web page according to embodiments of the invention; and

FIG. 4 illustrates a block diagram of a computing system according to embodiments of the invention.

In the following description, reference is made to the accompanying drawings which form a part thereof, and which illustrate several embodiments of the present invention. It is understood that other embodiments may be utilized and structural and operational changes may be made without departing from the scope of the present invention. The use of the same reference symbols in different drawings indicates similar or identical items.

### DETAILED DESCRIPTION OF THE INVENTION

The following description is presented to enable any person of ordinary skill in the art to make and use the invention. Descriptions of specific materials, techniques, and applications are provided only as examples. Various modifications to the examples described herein will be readily apparent to those of ordinary skill in the art, and the general principles defined herein may be applied to other examples and applications without departing from the spirit and scope of the invention. Thus, the present invention is not intended to be limited to the examples described and shown.

Users are able to personalize webpages in a variety of ways. For example, users are able to personalize the appearance of webpages, such as color or layout. Another mechanism to personalize webpages is to be able to define content within the webpage. Content may be related to a user's location, such as TV listings or weather. Content may include news that is of interest to the user. Other content, such as news, may be associated with a time. This content associated with time may be changing and updating constantly. Other content may include text data, video data or audio data and be embodied as, for example, web pages, emails, advertisements, news stories, digital videos, digital music, etc.

Embodiments of the invention enable selection of current relevant content from a larger content group to be provided.

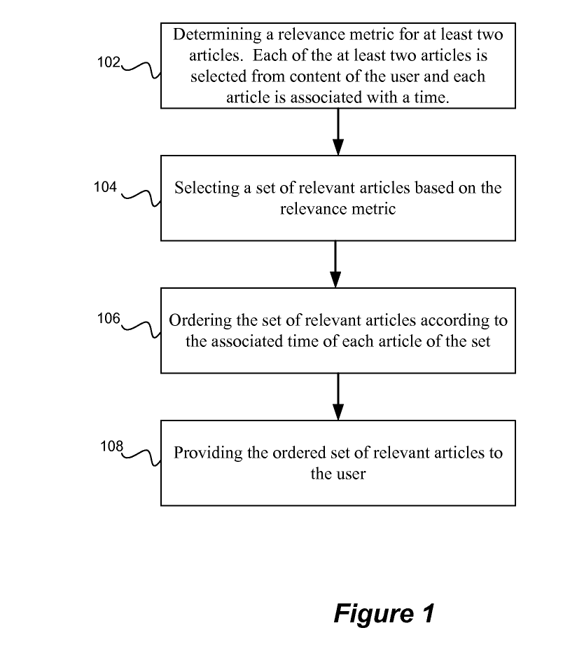

As illustrated in FIG. 1, a flowchart of the method 100 of providing relevant content on a web page for a user according to embodiments of the invention is shown. In 102, a relevance metric for at least two articles are determined. The relevance metric is a measure of relevancy to a specific user. A relevance metric may be based on a user profile, a user's click-through behavior, or general user behavior. User actions may indicate a user's interests. For example, actions, such as checking stock quotes every day, may indicate the user's interest in business.

A relevance metric may be a score that indicates the relevancy of content. The relevancy indicates topics in which the user expresses an interest. According to embodiments of the invention, a relevance metric may be based on machine learning algorithms, which extract rules or patterns from a plurality of labeled content items (e.g., training data) to generate and optimize a scoring model that may be used to score unlabeled content items. The machine learning algorithm used by embodiments of the invention may be that which is described in commonly owned U.S. application Ser. No. 11/642,392, filed Dec. 19, 2006 entitled “System and Method for Classifying a Content Item,” and U.S. application Ser. No. 11/676,728, filed Feb. 20, 2007, entitled “System and Method for Customizing a User Interface,” the disclosures of which are hereby incorporated by reference herein in their entirety. Those of ordinary skill in the art understand that other classification models or algorithms may be utilized, such as a neural network, k-Nearest Neighbor, support vector machines, etc.

For example, a machine learning algorithm for providing a relevance metric may include providing a prior probability distribution that is a normal distribution, a likelihood function and a labeled content item as input to a scoring component. A posterior probability distribution is constructed that is a normal distribution, the posterior probability distribution approximating the product of the likelihood function and the prior probability distribution. The posterior probability distribution is applied to a content item in a result set returned from a search component to determine a score for the content item. A training set comprising a plurality of labeled content items may be utilized by the method.

Construction of the posterior probability distribution may comprise computing a peak and a second derivative of the product and applying a Laplace approximation to the peak and the second derivative to obtain the normal distribution. Construction may also comprise representing the likelihood function as an axis of symmetry in a solution space with the normal distribution, generating a further normal distribution by rescaling, using a transformation function, the normal distribution to have an equal standard deviation in all directions about a peak thereof and generating a further axis of symmetry using the transformation function. A maximum of the product is determined on a solution line intersecting the rescaled further normal distribution and the further axis of symmetry. The solution line may be formed along a diameter of the rescaled further normal distribution and perpendicular to the further axis of symmetry. The output of this machine learning algorithm example provides a relevance metric.

Each article may be selected from content of the user. Content of the user may be content appearing on a personalized webpage. Content of the user may also include content from several webpages. Content may be received by RSS feeds. Furthermore, content may be user-defined. In embodiments of the invention, content may be, but is not limited to, personalized and customized content.

Each article is associated with a time. An article may be information that is constantly being updated. Articles associated with a time can be determined to be older or newer relative to another article associate with a time. An article, for example, may be, but is not limited to a news article.

After determining a relevance metric for the at least two articles, a set of relevant articles are selected based on the relevance metric in 104.

In 106, the set of relevant articles are ordered according to the associated time of each article. For example, the set of relevant articles may be ordered from most current to oldest. In this way, relevant articles are chosen from content of a user including a plurality of articles and ordered so that more current relevant articles can be provided to the user in 108. Even if content were filtered according to time and then sorted by relevance, it would not be obvious to the user which of the provided content is the most current.

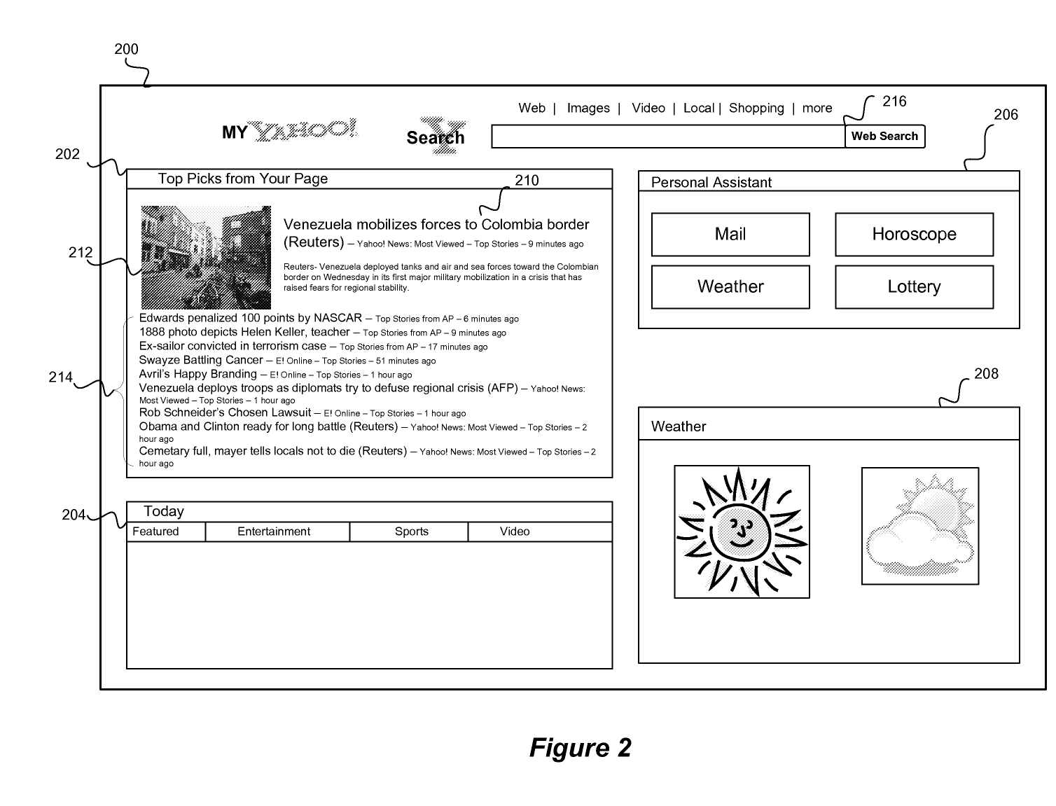

FIG. 2 illustrates embodiments of relevant content provided to a user according to embodiments of the invention. The relevant articles, or content, as determined in the aforementioned method, may be provided to a user on a webpage 200. The webpage 200 may include content that was chosen by the user to be provided on the webpage 200. The webpage 200 may include a field for performing a web search 116.

In FIG. 2, content of the user may include content provided in modules 204, 206, and 208, for example. A relevance metric is determined for the articles from modules 204, 206, and 208, for example. Then, from the relevance metrics, it is determined which of the articles is the most relevant for the user. After the relevant set of articles is selected and ordered according to the time associated with each article, the user is provided the relevant content in a module 202. The module containing the relevant content 202 may be displayed at the top of the webpage, such that the user is able to review its contents conveniently.

The most current relevant article 210 has been ordered to be first in the set of relevant articles. An image 212 associated with the most current relevant article 210 may also be displayed along with the most current relevant article. In some embodiments, if the most current relevant article does not have an associated image, the next most current article that is associated with an image may be provided first.

The other relevant articles 214 included in the relevant set ordered by time are also provided in module 202. In this way, the user is provided with relevant content from the rest of the webpage, ordered by time.

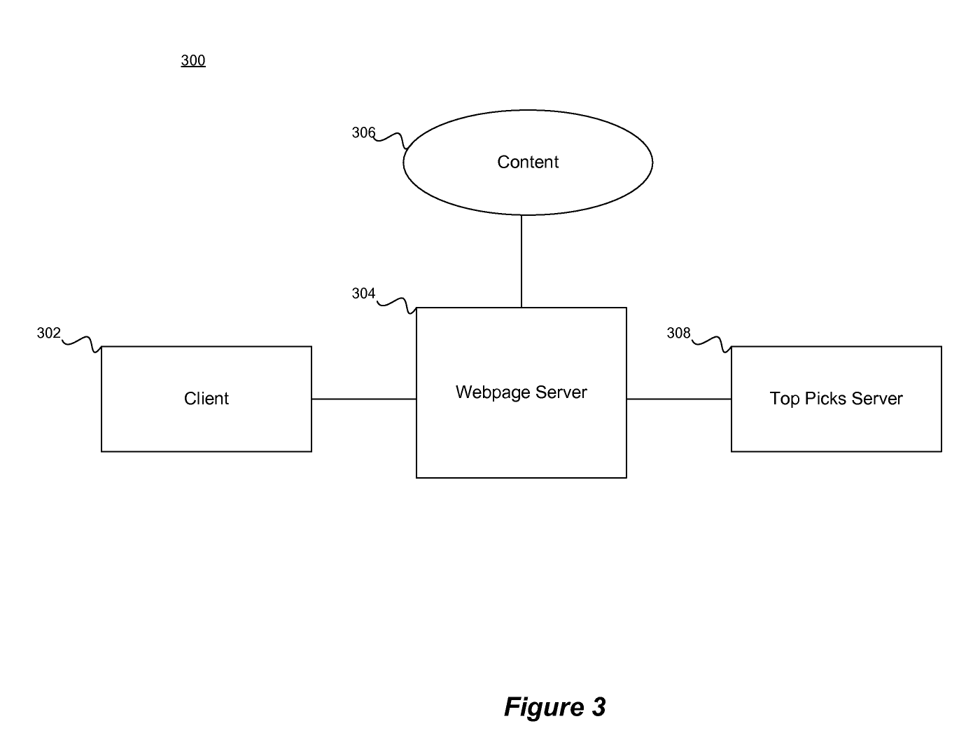

FIG. 3 illustrates a block diagram of an apparatus 300 for providing relevant content on a web page according to embodiments of the invention. Webpage server 304 generates and provides the client 302 a webpage including the user content. The webpage server 304 receives content input 306. The content input 306 may include news, stocks, or weather information, for example. A user may define a webpage at the webpage server 304 to include certain content. A top picks server 308 is associated with the webpage server 304. The top picks server 308 determines the relevance metric for the user content and selects the relevant set of articles. The top picks server 308 also orders the relevant set of articles according to the time associated with each article. The ordered set is provided to the webpage server 304 to provide to the user on a generated webpage.

While aspects of the invention, including the above described systems and methods, are described in terms of particular embodiments and illustrative figures, those of ordinary skill in the art will recognize that the invention is not limited to the embodiments or figures described. Those skilled in the art will recognize that the operations of the various embodiments may be implemented using hardware, software, firmware, or combinations thereof, as appropriate. For example, some processes can be carried out using processors or other digital circuitry under the control of software, firmware, or hard-wired logic. (The term “logic” herein refers to fixed hardware, programmable logic, and/or an appropriate combination thereof, as would be recognized by one skilled in the art to carry out the recited functions.) Software and firmware can be stored on computer-readable media. Some other processes can be implemented using analog circuitry, as is well known to one of ordinary skill in the art. Additionally, memory or other storage, as well as communication components, may be employed in embodiments of the invention.

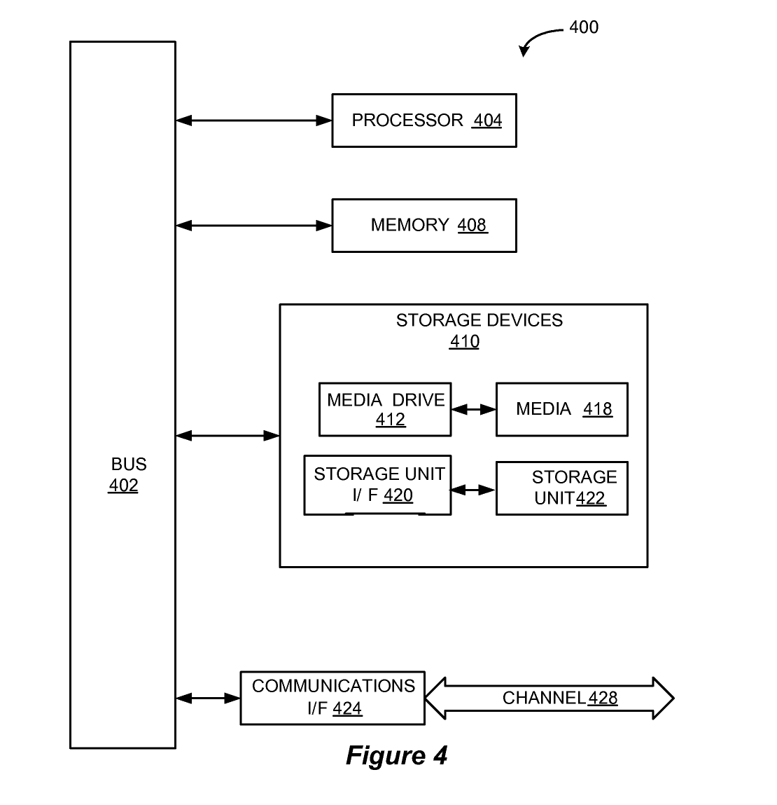

FIG. 4 illustrates an exemplary computing system 400 that may be employed to implement processing functionality for various aspects of the invention (e.g., as a server device, client device, database, combinations thereof, and so on). Those skilled in the relevant art will also recognize how to implement the invention using other computer systems or architectures. Computing system 400 may represent, for example, a desktop, mainframe, server, client, or any other type of special or general purpose computing device as may be desirable or appropriate for a given application or environment. Computing system 400 can include one or more processors, such as a processor 404. Processor 404 can be implemented using a general or special purpose processing engine such as, for example, a microprocessor, microcontroller or other control logic. In this example, processor 404 is connected to a bus 402 or other communication medium.

Computing system 400 can also include a main memory 408, for example random access memory (RAM) or other dynamic memory, for storing information and instructions to be executed by processor 404. Main memory 408 also may be used for storing temporary variables or other intermediate information during execution of instructions to be executed by processor 404. Computing system 400 may likewise include a read only memory (“ROM”) or other static storage device coupled to bus 402 for storing static information and instructions for processor 404.

The computing system 400 may also include information storage mechanism 410, which may include, for example, a media drive 412 and a removable storage interface 420. The media drive 412 may include a drive or other mechanism to support fixed or removable storage media, such as a hard disk drive, a floppy disk drive, a magnetic tape drive, an optical disk drive, a CD or DVD drive (R or RW), or other removable or fixed media drive. Storage media 418 may include, for example, a hard disk, floppy disk, magnetic tape, optical disk, CD or DVD, or other fixed or removable medium that is read by and written to by media drive 414. As these examples illustrate, the storage media 418 may include a computer-readable storage medium having stored therein particular computer software or data.

In alternative embodiments, information storage mechanism 410 may include other similar instrumentalities for allowing computer programs or other instructions or data to be loaded into computing system 400. Such instrumentalities may include, for example, a removable storage unit 422 and an interface 420, such as a program cartridge and cartridge interface, a removable memory (for example, a flash memory or other removable memory module) and memory slot, and other removable storage units 422 and interfaces 420 that allow software and data to be transferred from the removable storage unit 418 to computing system 400.

Computing system 400 can also include a communications interface 424. Communications interface 424 can be used to allow software and data to be transferred between computing system 400 and external devices. Examples of communications interface 424 can include a modem, a network interface (such as an Ethernet or other NIC card), a communications port (such as for example, a USB port), a PCMCIA slot and card, etc. Software and data transferred via communications interface 424 are in the form of signals which can be electronic, electromagnetic, optical, or other signals capable of being received by communications interface 424. These signals are provided to communications interface 424 via a channel 428. This channel 428 may carry signals and may be implemented using a wireless medium, wire or cable, fiber optics, or other communications medium. Some examples of a channel include a phone line, a cellular phone link, an RF link, a network interface, a local or wide area network, and other communications channels.

In this document, the terms “computer program product” and “computer-readable medium” may be used generally to refer to media such as, for example, memory 408, storage device 418, storage unit 422, or signal(s) on channel 428. These and other forms of computer-readable media may be involved in providing one or more sequences of one or more instructions to processor 404 for execution. Such instructions, generally referred to as “computer program code” (which may be grouped in the form of computer programs or other groupings), when executed, enable the computing system 400 to perform features or functions of embodiments of the present invention.

In an embodiment where the elements are implemented using software, the software may be stored in a computer-readable medium and loaded into computing system 400 using, for example, removable storage drive 414, drive 412 or communications interface 424. The control logic (in this example, software instructions or computer program code), when executed by the processor 404, causes the processor 404 to perform the functions of the invention as described herein.

It will be appreciated that, for clarity purposes, the above description has described embodiments of the invention with reference to different functional units and processors. However, it will be apparent that any suitable distribution of functionality between different functional units, processors or domains may be used without detracting from the invention. For example, functionality illustrated to be performed by separate processors or controllers may be performed by the same processor or controller. Hence, references to specific functional units are only to be seen as references to suitable means for providing the described functionality, rather than indicative of a strict logical or physical structure or organization.

Although the present invention has been described in connection with some embodiments, it is not intended to be limited to the specific form set forth herein. Rather, the scope of the present invention is limited only by the claims. Additionally, although a feature may appear to be described in connection with particular embodiments, one skilled in the art would recognize that various features of the described embodiments may be combined in accordance with the invention. Moreover, aspects of the invention describe in connection with an embodiment may stand alone as an invention.

Furthermore, although individually listed, a plurality of means, elements or method steps may be implemented by, for example, a single unit or processor. Additionally, although individual features may be included in different claims, these may possibly be advantageously combined, and the inclusion in different claims does not imply that a combination of features is not feasible and/or advantageous. Also, the inclusion of a feature in one category of claims does not imply a limitation to this category, but rather the feature may be equally applicable to other claim categories, as appropriate.

Moreover, it will be appreciated that various modifications and alterations may be made by those skilled in the art without departing from the spirit and scope of the invention. The invention is not to be limited by the foregoing illustrative details.

What is claimed is:

1. A computer-readable medium encoded with computer instructions for providing relevant content on a web page for a user, the instructions including instructions for:
determining a relevance metric for at least two articles, wherein each article is selected from content of the user, and each article is associated with a time;
selecting a set of relevant articles based on the relevance metric;
ordering the set of relevant articles according to the associated time of each article of the set; and
providing the ordered set of relevant articles to the user.

2. The computer-readable medium of claim 1, wherein the relevance metric is determined based in part on click behavior of the user.

3. The computer-readable medium of claim 1, wherein the content is personalized.

4. The computer-readable medium of claim 1, wherein the instructions further comprise instructions for determining the most relevant article of the ordered set associated with an image.

5. The computer-readable medium of claim 4, wherein the instructions further comprise instructions for providing the image of the first article, if the first article of the ordered set is associated with an image.

6. The computer-readable medium of claim 4, wherein the instructions further comprise instructions for ordering the ordered set so that the most relevant article associated with an image is first in the ordered set.

7. The computer-readable medium of claim 1, wherein the content is content from a customized webpage of the user.

8. The computer-readable medium of claim 1, wherein the relevance metric is further determined based in part on a pre-determined profile of the user.

9. The computer-readable medium of claim 1, wherein the instructions further comprise instructions for:
determining duplicate articles in the ordered set; and
removing duplicate articles from the ordered set.

10. The computer-readable medium of claim 1, wherein the personalized content is generated from RSS feeds.

11. A method for providing relevant content on a web page for a user, the method comprising:
determining a relevance metric for at least two articles, wherein each article is selected from content of the user, and each article is associated with a time;
selecting a set of relevant articles based on the relevance metric;
ordering the set of relevant articles according to the associated time of each article of the set; and
providing the ordered set of relevant articles to the user.

12. The method of claim 11 further comprising determining the most relevant article of the ordered set associated with an image.

13. The method of claim 12 further comprising providing the image of the first article, if the first article of the ordered set is associated with an image.

14. The method of claim 12 further comprising ordering the ordered set so that the most relevant article associated with an image is first in the ordered set.

15. The method of claim 11, wherein the content is content from a customized webpage of the user.

16. The method of claim 11, wherein the relevance metric is further determined based in part on a pre-determined profile of the user.

17. The method of claim 11 further comprising:
determining duplicate articles in the ordered set; and
removing duplicate articles from the ordered set.

18. The method of claim 11, wherein the personalized content is generated from RSS feeds.

19. An apparatus for providing relevant content on a web page for a user, the apparatus comprising:
logic operable for determining a relevance metric for at least two articles, wherein each article is selected from content of the user, and each article is associated with a time;
logic operable for selecting a set of relevant articles based on the relevance metric;
logic operable for ordering the set of relevant articles according to the associated time; and
logic operable for providing the ordered set of relevant articles to the user.

20. The apparatus of claim 19 further comprising logic for determining the most relevant article of the ordered set associated with an image.

21. The apparatus of claim 20 further comprising logic for providing the image of the first article, if the first article of the ordered set is associated with an image.

22. The apparatus of claim 20 further comprising logic for ordering the ordered set so that the most relevant article associated with an image is first in the ordered set.

23. The apparatus of claim 19 further comprising logic operable for receiving personalized content from a customized webpage of the user.

24. The apparatus of claim 19, wherein the logic for determining the relevance metric further includes logic for determining the relevance metric based in part on a pre-determined profile of the user.

25. The apparatus of claim 19 further comprising:
logic for determining duplicate articles in the ordered set; and
logic for removing duplicate articles from the ordered set.

26. The apparatus of claim 19 further comprising logic operable for receiving personalized content from RSS feeds.
